(19) United States
(12) Patent Application Publication
(10) Pub. No.: US 2011/0007164 A1
(43) Pub. Date: Jan. 13, 2011

(54) REMOTE IP CONTROLLED CONCEALED CAM DEVICE AND METHODS OF USE

(76) Inventor: Donald DiFrisco, Jupiter, FL (US)

Correspondence Address: MICHAEL RIES, 318 PARKER PLACE, OSWEGO, IL, 60543, US

(21) Appl. No.: 12/832,051

(22) Filed: Jul. 7, 2010

Related U.S. Application Data
(60) Provisional application No. 61/224,578, filed on Jul. 10, 2009.

(51) Int. Cl. H04N 7/18

(52) U.S. Cl. 348/151; 348/E07.087

(57) ABSTRACT

The present invention is a remotely IP controlled concealed cam device and methods of use. The device includes a concealed cam to record video and audio functions, one or more power sources, a memory that includes an operating system, a network communications module, a web browser module, a web server module, an audio and video application that allows audio and video selection, switching and integration from other audio and video sources, one or more buses that communicate information between the transmitter, the concealed cam, the power sources and the memory and an exterior shape that encases the transmitter, the cam, the power sources, the memory and the buses. The exterior shape can be a suitcase, a water cooler, a drink cup, a fire extinguisher or a computer. There is also a communications network that allows a client system to remotely control the device and the cam of the device.

This application claims priority to U.S. Provisional Application 61/224,578 filed on Jul. 10, 2009, the entire disclosure of which is incorporated by reference.

### TECHNICAL FIELD & BACKGROUND

The present invention generally relates to a remotely controlled concealed cam device and methods of use. More specifically, the invention is a remote IP controlled concealed cam device and methods of use that can take the exterior shape of a number of devices.

It is also an object of the invention to provide a remote IP controlled concealed cam device and methods of use that can be panned and zoomed from a client computer or other IP device over the Internet.

It is also an object of the invention to provide a remote IP controlled concealed cam device and methods of use that can follow a person's natural movement while the concealed cam is recording.

It is also an object of the invention to provide a remote IP controlled concealed cam device and methods of use that takes the exterior shape of a suitcase, a water cooler, a drink cup, a fire extinguisher or a computer.

What is really needed is a remote IP controlled concealed cam device and methods of use that can take the exterior shape of a suitcase, a water cooler, a drink cup, a fire extinguisher or a computer that allows a user to pan and zoom the concealed cam from a remote location using a computer or other IP controlling device that can follow a person's natural movement while the concealed cam is recording.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a diagram of the exterior shapes of a remotely controlled concealed cam device, in accordance with one embodiment of the present invention.

FIG. 2 illustrates a flow chart of a remotely controlled concealed cam device being used with a plurality of client systems, in accordance with one embodiment of the present invention.

FIG. 3 illustrates a block diagram of a remotely controlled concealed cam device, in accordance with one embodiment of the present invention.

FIG. 4 illustrates a block diagram of a client computer system used to access a remotely controlled concealed cam device, in accordance with one embodiment of the present invention.

FIG. 5 illustrates a flow chart of a method for using a remotely controlled concealed cam device, in accordance with one embodiment of the present invention.

FIG. 6 illustrates a flow chart of a method for activating a transmitter for a remotely controlled concealed cam device, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

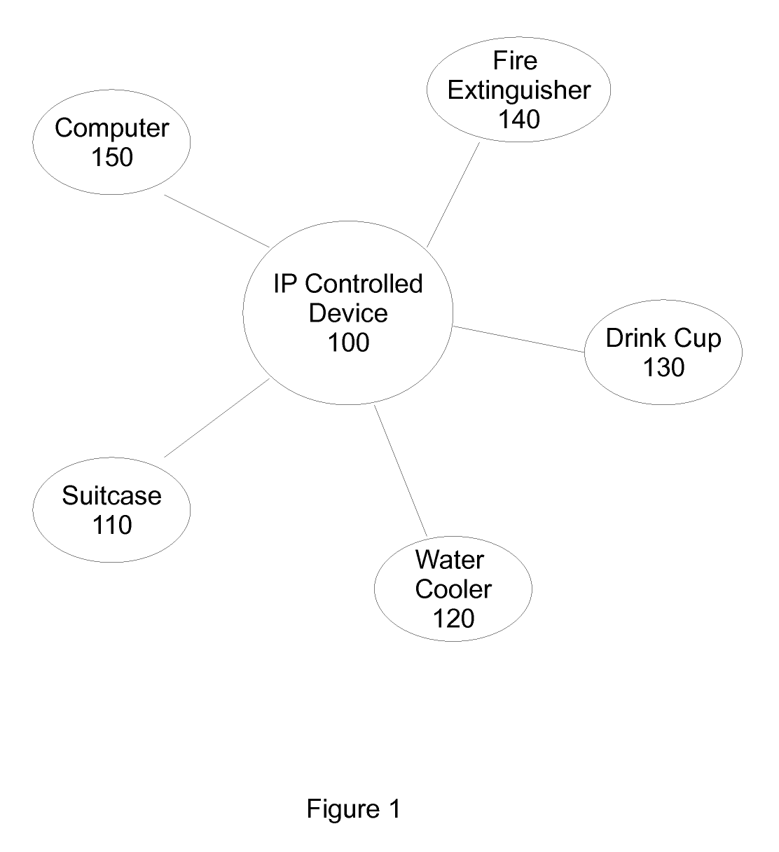

FIG. 1 illustrates a diagram of the exterior shapes a remotely controlled concealed cam device 100, in accordance with one embodiment of the present invention. The remotely controlled concealed cam device 100 can take the exterior shape of a suitcase 110, a water cooler 120, a drink cup 130, a fire extinguisher 140 and a computer 150. All of the subsequent features of the remotely controlled concealed cam device 100 are included in the suitcase 110, the water cooler 120, the drink cup 130, the fire extinguisher 140 and the computer 150 exterior shapes of the remotely controlled concealed cam device 100.

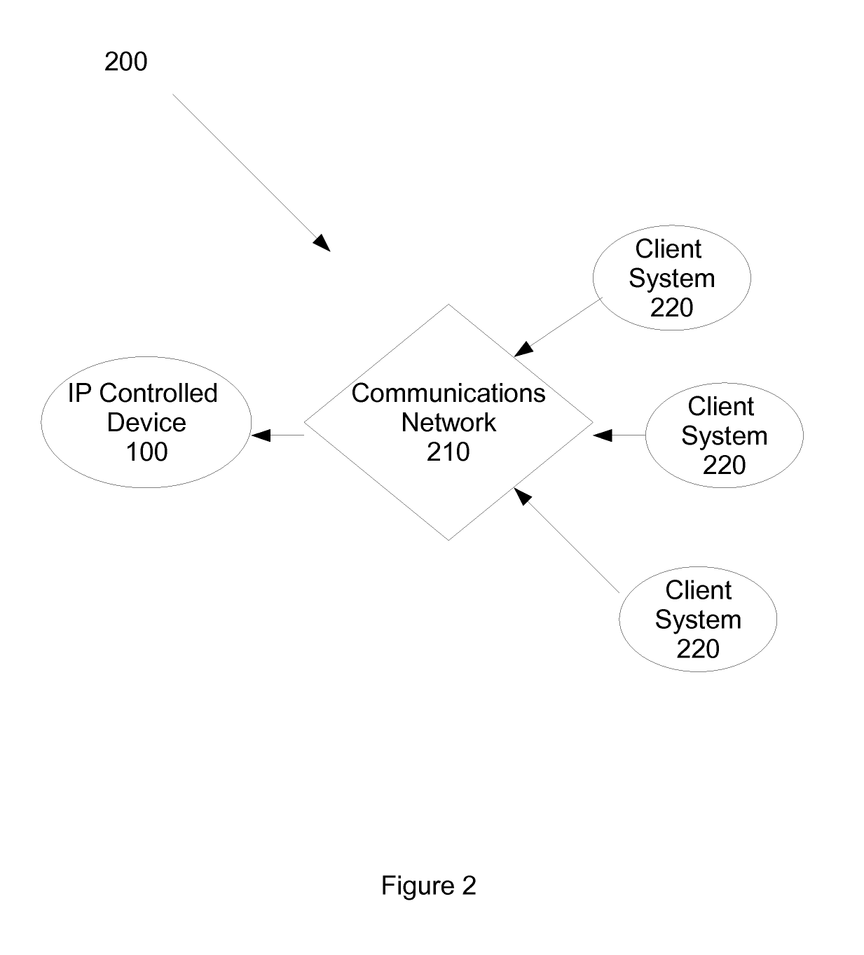

FIG. 2 illustrates a flow chart of a remotely IP controlled concealed cam device being used with a plurality of client systems 200 in accordance with one embodiment of the present invention. The remotely IP controlled concealed cam device 100 can be accessed by a communications network 210, such as a local area network, a wide area network, a wireless network, a telephone network, an intranet and the Internet. There are one or more client systems 220 that can access the IP controlled device 100 over the communications network 210. In other embodiments, the remotely IP controlled concealed cam device 200 being used with one or more client systems 220 may include additional components and/or may not include all of the components listed above.

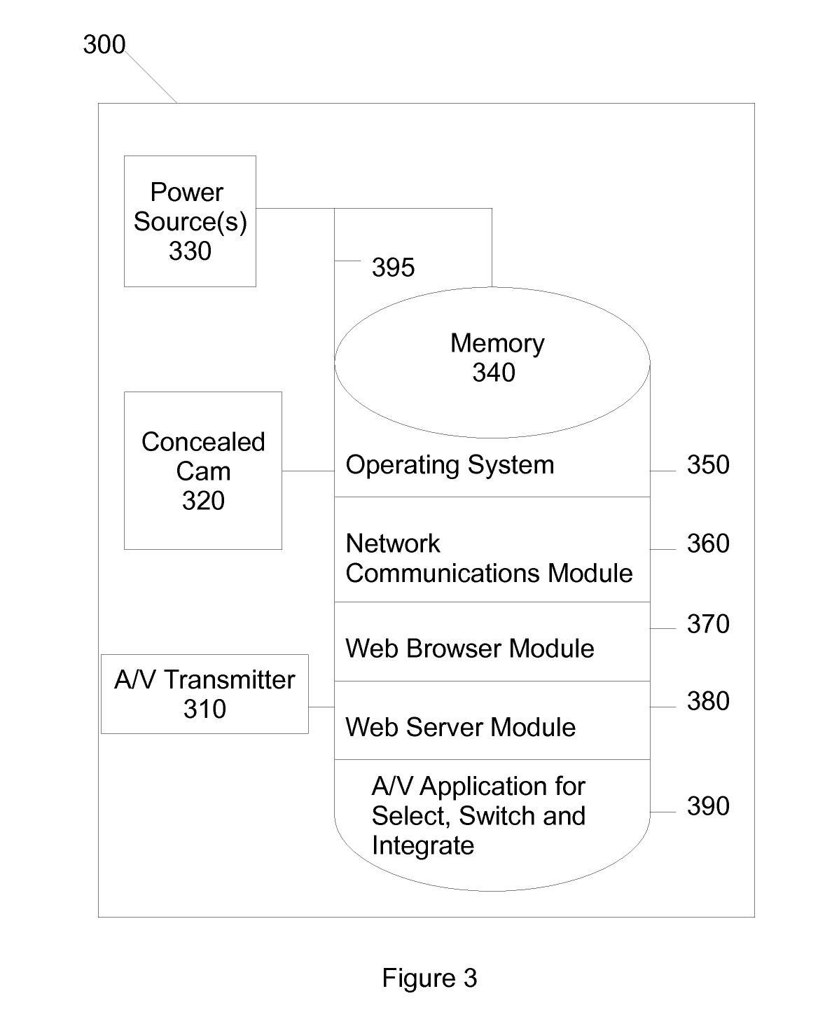

FIG. 3 illustrates a block diagram of a remotely controlled concealed cam device 300, in accordance with one embodiment of the present invention. The device 100 has an audio and video transmitter 310, a concealed cam 320 with one or more first power sources 330, a memory 340, an operating system 350, a network communications module 360, a web browser module 370, a web server module 380 and a software application that allows audio and video selection, switching and integration from other video sources 390 that is in communication with the audio and video transmitter 310 through one or more first buses 395. In other embodiments, the remotely controlled concealed cam device 100 may include additional components and/or may not include all of the components listed above.

The audio and video transmitter 310 controls the concealed cam's 320 audio and video functions and has the ability to control the panning and zooming functions of the concealed cam 320 from a client system 220. The audio and video transmitter 310 also automatically follows an intruder or other person as well when the intruder is on the concealed cam 320, since the concealed cam 320 can follow the intruder's or other person's natural movements.

The concealed cam 320 is directly controlled by the audio and video transmitter 310, which is controlled by one or more of the client systems 210. The concealed cam 320 can also be a black and white cam or a colored cam. The concealed cam 320 utilizes HM 264 compression images and its audio utilizes a 700 MHz frequency for less noise and better penetration. The concealed cam 320 is also concealed within the suitcase exterior shape 110, the water cooler exterior shape 120, the drink cup exterior shape 130, the fire extinguisher exterior shape 140 and the computer exterior shape 150, but can still clearly record audio and video activity. There are also one or more power sources 330, such as an AC power source or battery. Other power sources 330 that are well known in the art can also be used.

The memory 340 can include any one of, some of, any combination of, or all of a long term storage system, such as a hard drive, a short term storage system, such as random access memory, a removable storage system, such as a floppy drive or a removable drive and/or flash memory. The memory 340 may include one or more machine-readable mediums that may store a variety of different types of information. The term machine-readable medium is used to refer to any medium capable of carrying information that is readable by a machine. One example of a machine-readable medium is a computer-readable medium. The memory 340 may store one or more machine instructions for using the remote IP controlled concealed cam device 100. The operating system 350 is provided on the memory 340 to control the remote IP controlled concealed cam device 100. The network communications module 360 enables the remotely controlled concealed cam device 100 to communicate on the communications network 210 and is stored on the memory 340. The web browser module 370 allows for browsing the Internet and is stored on the memory 340. The web server module 380 is software provided to allow for browsing on the Internet. The software application that allows audio and video selection, switching and integration from other video sources 390 controls the activity of the concealed cam 320 and the audio and video transmitter 310.

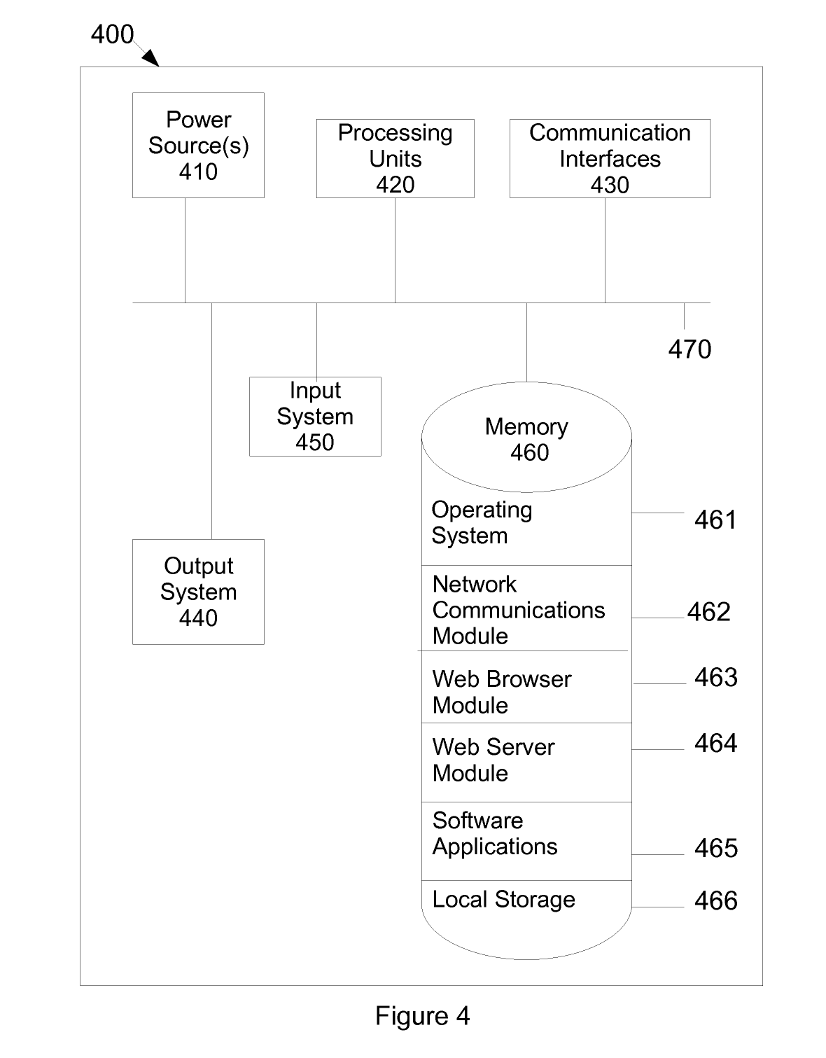

FIG. 4 illustrates a block diagram of a client system used to access a remotely controlled concealed cam device 400, in accordance with one embodiment of the present invention. The block diagram of the client system 400 includes one or more power sources 410, one or more processing units 420, one or more communication interfaces 430, an output system 440, an input system 450, a memory 460 with an operating system 461, a network communication module 462, a web browser module 463, a web server module 464, software applications 465, local storage 466 and one or more buses 470. In other embodiments, the client system 220 may include additional components and/or may not include all of the components listed above.

The power source 410 can be an AC power source, a battery or any other power source that is well known in the art. The processing units 420 can include multiple parallel processors, a single processor, a system of processors having one or more central processors, one or more digital signal processors (DSPs) that can also be used to replace of one or more central processing units (CPUs) and one or more digital signal processing programs that run on one or more CPUs. The communication interfaces 430 allow the client system 220 to interface with the network 210.

The output system 440 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or Internet.

The input system 450 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or Internet (e.g., IrDA, USB).

The memory 460 may include, for example, any one of, some of, any combination of, or all of a long term storage system, such as a hard drive, a short term storage system, such as random access memory, a removable storage system, such as a floppy drive or a removable drive and/or flash memory. The memory 460 may include one or more machine-readable mediums that may store a variety of different types of information. The term machine-readable medium is used to refer to any medium capable of carrying information that is readable by a machine. One example of a machine-readable medium is a computer-readable medium. The memory system 460 may store one or more machine instructions for using the remote IP controlled concealed cam device 100.

The operating system 461 is provided on the memory 460 to control the software and hardware of the remote IP controlled concealed cam device 100. The network communications module 462 enables the client system 220 to communicate on the communications network 210 and is stored on the memory 460. The web browser module 463 allows for browsing the Internet and is stored on the memory system 460. The web server module 464 is software provided to allow for browsing on the Internet. The software applications 465 are other software applications that can be used with the client system 220. There is also local storage 466 provided on the memory 460.

One or more buses 470 communicatively links the power source 410, the processing units 420, the communication interface 430, the output system 440, the input system 450 and the memory 460 to each other. One or more buses 470 may include any one of, some of, any combination of, or all of electrical cables, fiber optic cables, and/or sending signals through air or water (e.g. wireless communications), or the like. Some examples of sending signals through air and/or water include systems for transmitting electromagnetic waves such as infrared and/or radio waves and/or systems for sending sound waves.

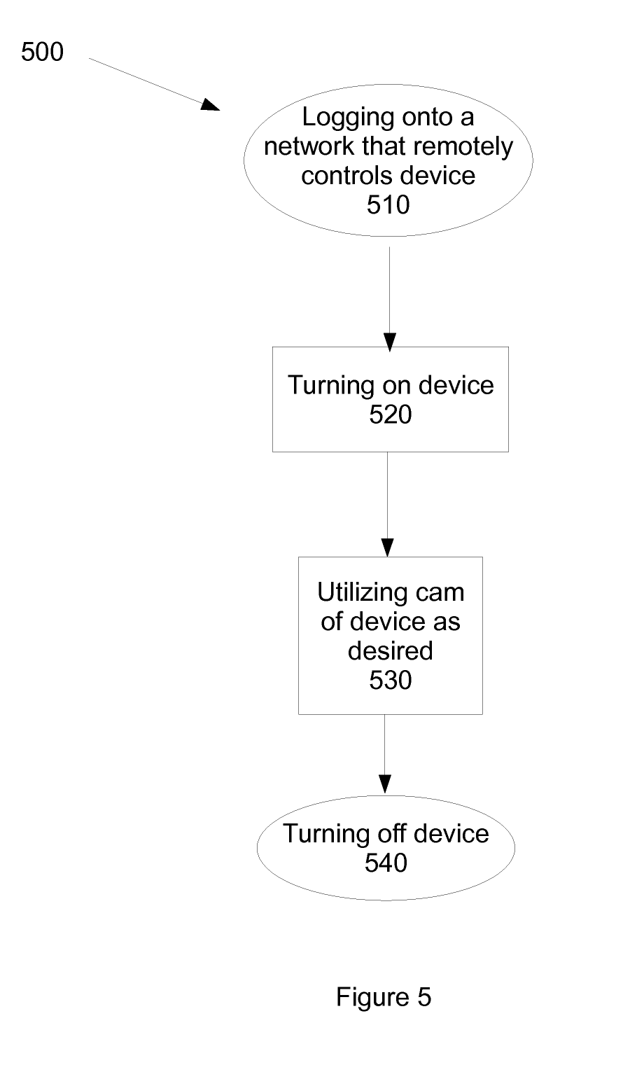

FIG. 5 illustrates a flow chart of a method for using a remotely controlled concealed cam device 500, in accordance with one embodiment of the present invention. The method for using a remotely controlled concealed cam device 500 includes the steps of logging onto a communications network that remotely controls the remotely controlled concealed cam device 510, turning-on the remotely controlled concealed cam device 520, utilizing the concealed cam as the user desires from the remotely controlled concealed cam device 530 and turning-off the remotely controlled concealed cam device 540. In another embodiment, although depicted as distinct steps in FIG. 5, steps 510-540 may not be distinct steps. In another embodiment, although depicted as distinct steps in FIG. 5, steps 510-540 may not be distinct steps. In other embodiments, method 500 may not have all of the above steps and/or may have other steps in addition to or instead of those listed above. The steps of method 500 may be performed in another order. Subsets of the steps listed above as part of method 500 may be used to shape their own method.

Desired uses of the concealed cam 320 from the remotely controlled concealed cam device 100 include panning and zooming the concealed cam 320 as desired by the user. The concealed cam 320 also follows an intruder or other person automatically when the intruder or other person is on the concealed cam 320.

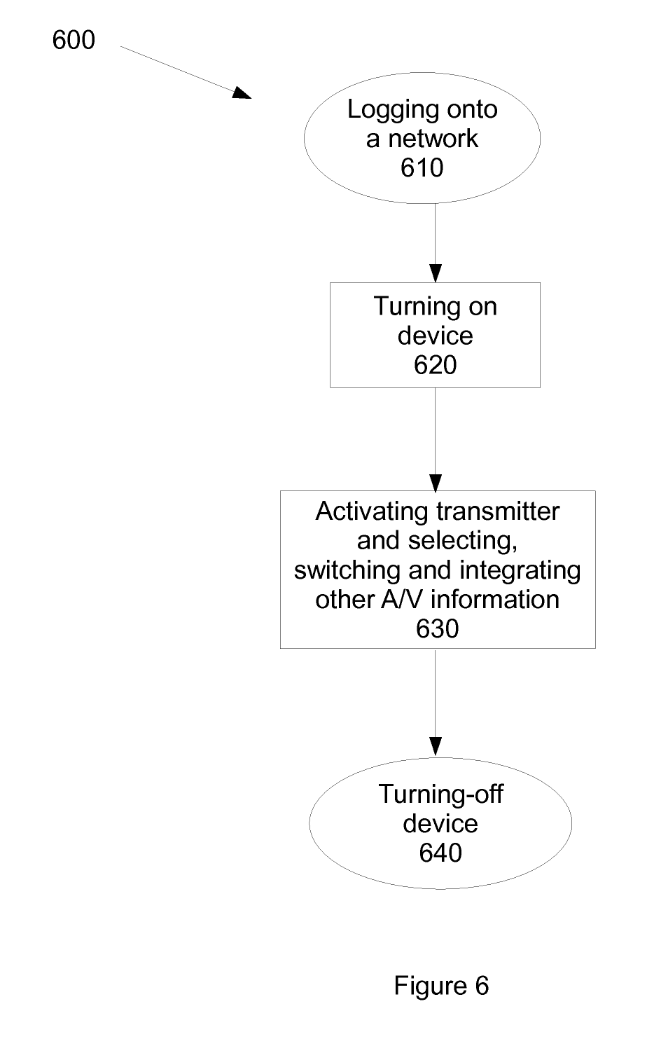

FIG. 6 illustrates a flow chart of a method for activating a transmitter for a remotely controlled concealed cam device for a user 600, in accordance with one embodiment of the present invention. The method for activating a transmitter for selecting, switching and integrating audio and visual data for a remotely controlled concealed cam device 600 includes the steps of logging onto a communications network 610, turning-on the remotely controlled concealed cam device 620, activating a transmitter and selecting, switching and integrating audio and visual data from a plurality of sources 630 and turning-off the remotely controlled concealed cam device 640. In another embodiment, although depicted as distinct steps in FIG. 6, steps 610-640 may not be distinct steps. In another embodiment, although depicted as distinct steps in FIG. 6, steps 610-640 may not be distinct steps. In other embodiments, method 600 may not have all of the above steps and/or may have other steps in addition to or instead of those listed above. The steps of method 600 may be performed in another order. Subsets of the steps listed above as part of method 600 may be used to shape their own method.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A remotely controlled concealed cam device for a user, comprising:
an audio and video transmitter to control said device audio and video functions;
a concealed cam to record said device video and audio functions;
one or more power sources that provide power to said device;
a memory that includes an operating system, a network communications module, a web browser module, a web server module, an audio and video application that allows audio and video selecting, switching and integrating from other audio and video sources;
one or more buses that communicates information between said transmitter, said concealed cam, said power sources and said memory;
an exterior shape that encases said transmitter, said cam, said power sources, said memory and said buses; and
a communications network that includes a land area network, a wide area network, an intranet and the Internet for said device and a client system to exchange computer and electronic related data.

2. The device according to claim wherein said transmitter allows said user to pan and zoom said cam.

3. The device according to claim 1, wherein said transmitter allows said concealed cam to follow an intruder's or another person's natural movements.

4. The device according to claim 1, wherein said cam can be color or black and white.

5. The device according to claim 1, wherein said cam utilizes HM 264 compression images.

6. The device according to claim 1, wherein said audio utilizes a 700 MHz frequency for less noise and better penetration.

7. The device according to claim 1, wherein said power sources are an AC power source or battery.

8. The device according to claim 1, wherein said memories include a long term storage system, a short term storage system or a removable storage system.

9. The device according to claim 8, wherein said long term storage system is a hard drive.

10. The device according to claim 8, wherein said short term storage system is random access memory.

11. The device according to claim 8, wherein said removable storage system is a floppy drive, a removable drive or a flash memory.

12. The device according to claim 1, wherein said exterior shape is a suitcase.

13. The device according to claim 1, wherein said exterior shape is a water cooler.

14. The device according to claim 1, wherein said exterior shape is a drink cup.

15. The device according to claim 1, wherein said exterior shape is a fire extinguisher.

16. The device according to claim 1, wherein said exterior shape is a computer.

17. A method for using a client system to use a remotely controlled concealed cam device for a user, comprising:
logging said client system onto a communications network that allows said user to remotely control said device;
turning-on said device;
utilizing a concealed cam of said device as desired by said user; and
turning off said device.

18. The method according to claim 17, wherein said utilizing step includes panning and zooming said concealed cam.

19. The method according to claim 17, wherein said concealed cam can follow an intruder's or another person's natural movements.

20. A method for activating a transmitter for a remotely controlled concealed cam device for a user, comprising;
logging onto a communications network;
turning on said device;
activating said transmitter and selecting, switching and integrating other audio and video information; and
turning off said device.
